(19) United States
(12) Patent Application Publication
(10) Pub. No.: US 2026/0270653 A1
(43) Pub. Date: Sep. 10, 2026

(54) USER TERMINAL, MANAGING SERVER AND OPERATING METHOD THEREFOR

(71) Applicant: IPIN LABS, Inc., Seoul (KR)

(72) Inventor: Jae Hyun Yoo, Seoul (KR)

(73) Assignee: IPIN LABS, Inc., Seoul (KR)

(21) Appl. No.: 19/126,292

(22) PCT Filed: Aug. 23, 2023
(86) PCT No.: PCT/KR2023/012455

§ 371 Date: May 4, 2026

(30) Foreign Application Priority Data
Nov. 1, 2022 (KR) 10-2022-0143935
Apr. 12, 2023 (KR) 10-2023-0048396

(51) Int. Cl. H04W 4/029; H04W 4/02

(52) U.S. Cl. CPC H04W 4/029; H04W 4/023; H04W 4/027

(57) ABSTRACT

According to an embodiment disclosed in the present document, a management server comprises a communication circuit, a memory, and a processor operatively connected to the communication circuit and the memory, wherein the processor can receive signal strength data and movement characteristic data acquired while at least one portable terminal having a data collection SDK installed therein moves in a target space, estimate a relative position trajectory from the movement characteristic data by using a pre-trained relative position estimation model, train a position-tracking model for estimating an absolute position on the basis of the signal strength data and the relative position trajectory, and manage a position-tracking SDK including the trained position-tracking model.

### CROSS-CITATION WITH RELATED APPLICATIONS

This application claims the benefit of priority to Korean Patent Application No. 10-2022-0143935, filed on Nov. 1, 2022 and Korean Patent Application No. 10-2023-0048396, filed on Apr. 12, 2023, the entire contents of which are incorporated herein by reference.

### TECHNICAL FIELD

Embodiments disclosed in the specification relate to a user terminal for providing an indoor positioning service, a management server and an operating method therefor.

### BACKGROUND ART

With the development of electronic devices such as smartphones and tablet PCs, position-based services (e.g., position-based route guidance services using smartphones or navigation systems) using the electronic devices are becoming widely used.

To provide these services, positioning methods using satellite navigation systems such as GPS and Galileo are mainly used outdoors. However, these methods may provide accurate and reliable positioning outdoors, but may not guarantee the accuracy and reliability to the extent that commercialization is possible indoors (e.g., inside buildings, inside tunnels, underground, or the like).

Accordingly, a fingerprint technique that performs positioning by building a database (a pair of a position and a signal) of signals received at each point by using Wi-Fi, geomagnetic field, Bluetooth, or the like for indoor positioning and comparing the built database with the acquired signal pattern, and a dead-reckoning technique (e.g., Pedestrian Dead Reckoning (PDR) and Inertial Navigation System (INS)) that performs positioning by estimating a pedestrian's stride, speed, or direction from sensor data acquired depending on the pedestrian's walking have been mainly used.

However, the fingerprint technique requires a lot of time and costs to build an accurate database for high positioning accuracy. In addition, in the fingerprint technique, the training data is collected statically, while the general positioning service providing environment is dynamic. Because the dead-reckoning technique is based on the relative movement of a pedestrian, not only an absolute reference is needed to determine an actual position, but also tuning of various parameters according to characteristics (e.g., a stride, a height, an age, and the like) of the pedestrian is required.

### DETAILED DESCRIPTION OF THE INVENTION

### Technical Problem

Nowadays, in a situation where the obligation to manage and supervise users at construction sites is increasing due to the enactment of the Serious Disaster Punishment Act, the need for accurate position-tracking of users in indoor areas such as tunnels and underground is increasing.

Accordingly, a new training technique is proposed to overcome limitations of database construction time and to dynamically collect data. In particular, a new positioning method, which has not been proposed before, is proposed to reduce the time and costs required to collect data by not obtaining position information in a process of collecting data on a signal, and to perform training by fusing a virtual position, which is obtained by using dead-reckoning, with signal data.

### Technical Solution

According to an embodiment disclosed in this specification, a management server may include a communication circuit, a memory, and a processor operatively connected to the communication circuit and the memory. The processor may receive signal strength data and a relative position trajectory estimated based on movement characteristic data acquired while at least one portable terminal, in which a data collection SDK is installed, moves in a target space, may train a position-tracking model for estimating an absolute position based on the signal strength data and the relative position trajectory, and may manage a position-tracking SDK including the trained position-tracking model.

According to an embodiment disclosed in this specification, an operating method of a management server may include receiving signal strength data and a relative position trajectory estimated based on movement characteristic data acquired while at least one portable terminal, in which a data collection SDK is installed, moves in a target space, training a position-tracking model for estimating an absolute position based on the signal strength data and the relative position trajectory, and managing a position-tracking SDK including the trained position-tracking model.

According to an embodiment disclosed in this specification, a user terminal may include a communication circuit, a memory, and a processor operatively connected to the communication circuit and the memory. The processor may be configured to receive a position-tracking SDK from a management server, to install the position-tracking SDK in the memory, and to acquire movement characteristic data and signal strength data as a user moves within a target space, and to calculate an absolute position of the user from the signal strength data and the movement characteristic data by using the position-tracking SDK.

### Advantageous Effects of the Invention

According to an embodiment disclosed in the specification, a positioning service providing system may reduce costs and time required to collect data by dynamically obtaining only signal strength without obtaining or entering position information in a process of collecting signal strength data.

Moreover, according to an embodiment disclosed in the specification, the positioning service providing system may increase the accuracy of positioning by using the combined signal intensity data and movement characteristic data while costs and time required for collecting data are reduced.

Furthermore, according to an embodiment disclosed in the specification, the positioning service providing system may provide an optimized positioning service by training a position-tracking model with respect to a target space where the positioning service is provided.

Besides, a variety of effects directly or indirectly understood through the present disclosure may be provided.

### DESCRIPTION OF THE DRAWINGS

FIG. 1 is a block diagram showing a positioning service providing system, according to an embodiment disclosed in the specification.

FIG. 2 is a diagram showing a process of providing a positioning service in a positioning service providing system, according to an embodiment disclosed in the specification.

FIG. 3 is a diagram showing a process of estimating an absolute position from movement characteristic data and signal strength data, according to an embodiment disclosed in the specification.

FIG. 4 is a diagram showing an example of fusion of a relative position trajectory and signal strength data, according to an embodiment disclosed in the specification.

FIG. 5 is a diagram showing an example of a process of converting a plurality of relative position trajectories, according to an embodiment disclosed in the specification.

FIG. 6 is a diagram showing an example of mapping an absolute position onto a map, according to an embodiment disclosed in the specification.

(FIG. 7 is a block diagram showing a configuration of a management server, according to an embodiment disclosed in the specification.

FIG. 8 is a block diagram showing a configuration of a user terminal, according to an embodiment disclosed in the specification.

FIG. 9 is a flowchart for describing an operating method of a management server, according to an embodiment disclosed in the specification.

### BEST MODE

Hereinafter, various embodiments of the present disclosure will be described with reference to accompanying drawings. However, those of ordinary skill in the art will recognize that modification, equivalent, and/or alternative on various embodiments described herein may be variously made without departing from the scope and spirit of the present disclosure.

In this specification, the singular form of the noun corresponding to an item may include one or more of items, unless interpreted otherwise in context. In this specification, the expressions “A or B”, “at least one of A and B”, “at least one of A or B”, “A, B, or C”, “at least one of A, B, and C”, and “at least one of A, B, or C” may include any and all combinations of one or more of the associated listed items. The terms, such as “first” or “second” may be used to simply distinguish the corresponding component from the other component, but do not limit the corresponding components in other aspects (e.g., importance or order). When a component (e.g., a first component) is referred to as being “coupled with/to” or “connected to” another component (e.g., a second component) with or without the term of “operatively” or “communicatively”, it may mean that a component is connectable to the other component, directly (e.g., by wire), wirelessly, or through the third component.

Each component (e.g., a module or a program) of components described in this specification may include a single entity or a plurality of entities. According to various embodiments, one or more components of the corresponding components or operations may be omitted, or one or more other components or operations may be added. Alternatively or additionally, a plurality of components (e.g., a module or a program) may be integrated into one component. In this case, the integrated component may perform one or more functions of each component of the plurality of components in the manner same as or similar to being performed by the corresponding component of the plurality of components prior to the integration. According to various embodiments, operations executed by modules, programs, or other components may be executed by a successive method, a parallel method, a repeated method, or a heuristic method. Alternatively, at least one or more of the operations may be executed in another order or may be omitted, or one or more operations may be added.

The term “module” or “. . . unit” used herein may include a unit, which is implemented with hardware, software, or firmware, and may be interchangeably used with the terms “logic”, “logical block”, “part”, or “circuit”. The “module” may be a minimum unit of an integrated part or may be a minimum unit of the part for performing one or more functions or a part thereof. For example, according to an embodiment, the module may be implemented in the form of an application-specific integrated circuit (ASIC).

Various embodiments in this specification may be implemented with software (e.g., a program or an application) including one or more instructions stored in a storage medium (e.g., a memory) readable by a machine. For example, the processor of a machine may call at least one instruction of the stored one or more instructions from a storage medium and then may execute the at least one instruction. This enables the machine to operate to perform at least one function depending on the called at least one instruction. The one or more instructions may include a code generated by a complier or a code executable by an interpreter. The machine-readable storage medium may be provided in the form of a non-transitory storage medium. Herein, ‘non-transitory’ just means that the storage medium is a tangible device and does not include a signal (e.g., electromagnetic waves), and this term does not distinguish between the case where data is semipermanently stored in the storage medium and the case where the data is stored temporarily.

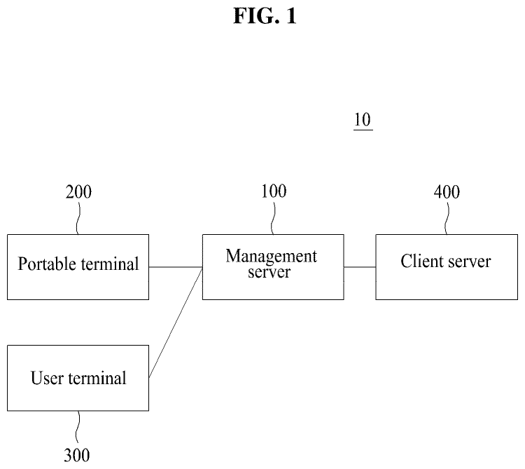

FIG. 1 is a block diagram showing a positioning service providing system, according to an embodiment disclosed in the specification.

Referring to FIG. 1, a positioning service providing system 10 according to an embodiment disclosed in the specification may include a management server 100, a portable terminal 200, a user terminal 300, and a client server 400.

The positioning service providing system 10 according to an embodiment may provide a position-tracking software development kit (SDK) including a position-tracking model to a client company requesting the provision of a positioning service, thereby enabling a client to predict positions of its users (more specifically, terminals carried by users) by using the position-tracking SDK. For example, when the positioning service providing system 10 receives a request for providing a positioning service from the client, the positioning service providing system 10 may provide a position-tracking SDK to the client's users.

The positioning service may be a service for positioning indoors. The positioning service may enable positioning by using a user's movement characteristics and the strength of a signal received by a user terminal even indoors where positioning using GPS or other methods is not possible.

According to an embodiment, the management server 100 may receive a request for providing a positioning service from a client and may provide the portable terminal 200 with a data collection SDK for data collection and/or a position-tracking SDK for position-tracking. The management server 100 may build a position-tracking model optimized for a target space where the client uses the positioning service, by training pieces of collected data and may manage the position-tracking SDK including a position-tracking model. For example, the management server 100 may enable positioning of users by distributing the position-tracking SDK to the client's users. For another example, the management server 100 may continuously update and manage the position-tracking model and the position-tracking SDK including the same depending on changes (e.g., structural changes, position changes, or the like) in the target space, changes in sensors of a terminal (e.g., a portable terminal) where the data collection SDK is installed, or the like.

The management server 100 may provide control of users by using an absolute position received from the user terminal 300. In an embodiment, the user terminal 300 may implement a control platform for providing the control of users and may provide the control platform to the client. The control platform may be a web platform. In this case, the client may access the control platform through the client server 400 and may receive user control of the management server 100.

According to an embodiment, the portable terminal 200 may include various types of electronic devices capable of performing data communication. For example, the portable terminal 200 may include a portable device such as a smartphone or tablet, a body-worn device such as a wearable device or a virtual reality (VR) device, a camera device, or the like and is not limited to the above-described devices as long as it may be carried and moved by a person. Moreover, the portable terminal 200 may include a server or gateway that is capable of transmitting data packets through an application. The portable terminal 200 may also be referred to as an “electronic device”.

The portable terminal 200 may be an electronic device managed by a client or an operator of the management server 100, or may be a terminal possessed by a user of the client or a user of the operator of the management server 100.

The portable terminal 200 may receive and store data collection SDK from the management server 100. For example, the portable terminal 200 may include a memory and may store the data collection SDK in the memory.

The portable terminal 200 may acquire movement characteristic data and signal strength data of a carrier while a carrier moves within the target space. Here, the target space may be a space where the client receives the position-tracking SDK to track the user's position. For example, when the client is a construction company, the target space may be a construction site. The movement characteristic data may include inertial sensor data, gyro sensor data, acceleration sensor data, or the like. The signal strength data may include Wi-Fi RSSI data, magnetic field data, Bluetooth data, or the like.

The portable terminal 200 may include a sensor unit for sensing a signal and sensing movement characteristics. For example, the sensor unit may include an inertial sensor, a gyro sensor, or an acceleration sensor for sensing movement characteristics, and may include an RF sensor, a Wi-Fi sensor, or a Bluetooth sensor for sensing signals. For example, the sensor unit may include a Wi-Fi sensor, and the Wi-Fi sensor may be configured to capture wireless signals within the target space and may obtain received signal strength indicator (RSSI) data from wireless access points within the target space, such as Wi-Fi access points. The sensor unit may be built into the portable terminal 200 and, in some cases, may be installed separately inside or outside the portable terminal 200.

The portable terminal 200 may estimate a relative position trajectory based on movement characteristic data. In more detail, the portable terminal 200 may obtain a relative position trajectory from movement characteristic data, which is obtained while it moves in a target space, by using the data collection SDK.

According to an embodiment, the data collection SDK may include a pre-trained relative position estimation model. The data collection SDK may estimate the relative position trajectory from the movement characteristic data by using the pre-trained relative position estimation model.

According to an embodiment, the data collection SDK may filter the acquired movement characteristic data and/or signal strength data. For example, the data collection SDK may use only data, which is obtained when the portable terminal 200 actually moves, to accurately estimate the relative position trajectory from the movement characteristic data. That is, pieces of data obtained in a situation where the portable terminal 200 is not moving may be filtered. To this end, the data collection SDK may determine whether the portable terminal 200 is moving, based on gyro sensor data or acceleration sensor data, which are included in the movement characteristic data.

There may be the at least one portable terminal 200. For example, to collect data for training a position-tracking model, a carrier of the portable terminal 200 may collect a plurality of training datasets by repeatedly walking by using the single portable terminal 200 during a specific period For another example, a plurality of carriers may collect the plurality of training datasets by using the plurality of portable terminals 200 by walking during a specific period. Each of the plurality of training datasets may include the signal strength data and the relative position trajectory.

The portable terminal 200 may deliver the obtained relative position trajectory and the obtained signal strength data to the management server 100.

The user terminal 300 may receive the position-tracking SDK from the management server 100. The user terminal 300 may be a terminal owned by a user of a client that is the target of position-tracking. The user terminal 300 may store the position-tracking SDK and may transmit the user's position (absolute position) calculated from the position-tracking SDK to the management server 100. The user's position may be a position of the user terminal 300.

The user terminal 300 may be substantially the same as the portable terminal 200. For example, the user terminal 300 and the portable terminal 200 may be operated as a single electronic device. For example, both the data collection SDK and the position-tracking SDK may be installed on a single terminal. The user may collect data through the data collection SDK during a data collection process through the corresponding terminal, and the user's position may be tracked by using the position-tracking SDK when the positioning service is provided.

The client server 400 may be a server managed by a client that requests for providing a positioning service. For example, the client server 400 may be a server used for the client to manage its users. For another example, the client server 400 may be a client terminal owned by the client, not a server. An administrator of the client server 400 may identify user control information, which is provided by the management server 100, by accessing a control platform provided by the management server 100. The administrator of the client server 400 may perform various management tasks such as managing users' commute to and from work, managing access to dangerous areas, managing movement trajectories by time of day, and managing material resources by using the user control information. For example, the administrator of the client server 400 may be a construction site supervisor, a site manager, or a monitoring manager in a control room. For another example, the client server 400 may receive absolute positions of users from the management server 100 and may directly perform user control using the absolute positions.

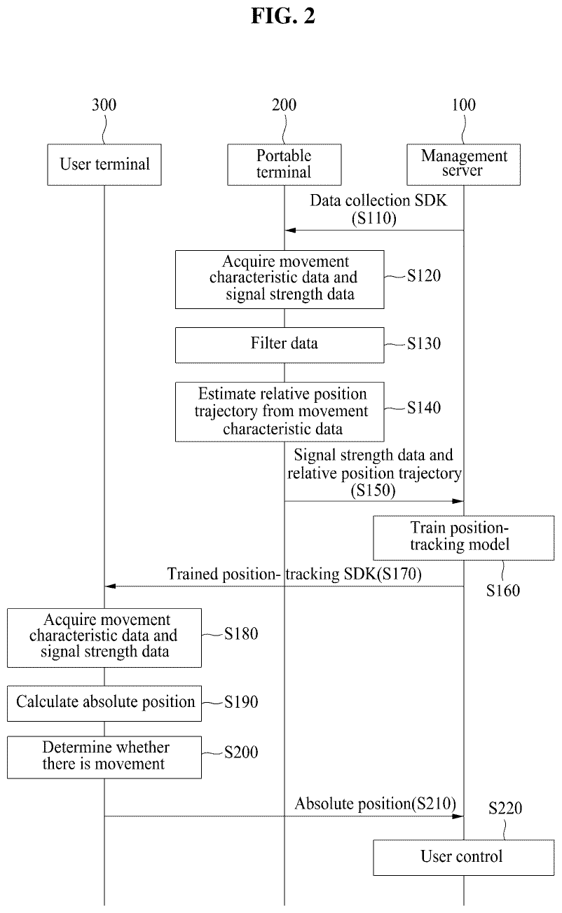

FIG. 2 is a diagram showing a process of providing a positioning service in a positioning service providing system, according to an embodiment disclosed in the specification. Operations illustrated in FIG. 2 may be performed by the management server 100, the portable terminal 200, and the user terminal 300 of FIG. 1.

Referring to FIG. 2, in operation S110, the portable terminal 200 may receive data collection SDK from the management server 100. For example, the portable terminal 200 may be an electronic device provided to a client by an operator of the management server 100. For example, the portable terminal 200 may be provided to the client while the data collection SDK is included. The data collection SDK may be configured to transmit pieces of data obtained from the portable terminal 200 to the management server 100. To this end, the data collection SDK may be equipped with an API for communicating with the portable terminal 200 and the management server 100.

In operation S120, the portable terminal 200 may acquire movement characteristic data and signal strength data.

The movement characteristic data may be data for detecting changes in the movement of a person (a carrier) carrying the portable terminal 200. For example, the movement characteristic data may include inertial sensor data, gyro sensor data, acceleration sensor data, and the like. The movement characteristic data may be a set of pieces of data obtained while a carrier moves in a target space while carrying the portable terminal 200. For example, the movement characteristic data may be obtained at a fixed period (e.g., 1 second) and may be composed of a set of data obtained periodically. For example, when ‘N’ pieces of data are obtained during the movement of the carrier, the movement characteristic data may be a set of ‘N’ pieces of data.

The signal strength data may be data regarding the strength of a signal received from a plurality of access points (APs) placed within the target space, and may be measurement data regarding a magnetic field distributed in the environment of the target space. For example, the signal strength data may be Wi-Fi RSSI data, geomagnetic field data, and the like. In this case, the signal strength data may be expressed as a vector for the strength of the signal received from each of the plurality of APs placed in the target space. For example, when there are ‘m’ Wi-Fi APs in the target space, the signal strength data obtained at a specific point in time may be an m-dimensional vector for a signal received from each of the ‘m’ Wi-Fi APs. Hereinafter, the signal strength data may be referred to identically as a signal strength vector.

The signal strength data may be obtained at a fixed interval (e.g., 5 seconds) and may be composed of a set of signal strength vectors obtained periodically. For example, when ‘P’ pieces of data are obtained during the movement of the carrier, the movement characteristic data may be a set of ‘P’ pieces of data.

It is important to note that the signal strength data only includes data regarding the strength of the signal being received, and does not include information about the position of a point at which the signal strength data is received. In other words, the positioning service providing system 10 according to an embodiment disclosed in the specification does not acquire or enter position information in a process of collecting signal strength data, and thus the time and costs required to collect data may be significantly reduced compared to a fingerprint technique that generally builds a database by obtaining or entering' position values with signal strength values in pairs.

According to an embodiment, the portable terminal 200 may obtain a plurality of training datasets by moving multiple times in the target space. For example, as a carrier of the portable terminal 200 repeatedly walks by using the single portable terminal 200 during a specific period, the plurality of training datasets may be collected to collect data for training a position-tracking model. For another example, as a plurality of carriers walk by using the plurality of portable terminals 200 during a specific period, the plurality of training datasets may be collected.

In operation S130, the portable terminal 200 may filter the acquired data. In more detail, the data collection SDK may filter the acquired movement characteristic data and/or signal strength data. For example, the data collection SDK may use only data, which is obtained when the portable terminal 200 actually moves, to accurately estimate the relative position trajectory from the movement characteristic data.

Furthermore, the data collection SDK may be configured to filter noise data of the movement characteristic data and the signal strength data, which are acquired from the portable terminal 200 and/or the user terminal 300. Here, the noise data may include data with abnormal values or low reliability due to distortion.

As such, the data collection SDK may be configured to filter the noise data and data acquired when there is no movement, thereby not only improving the accuracy of training during a training process, but also improving the accuracy of absolute position estimation during a positioning process.

In operation S140, the portable terminal 200 may estimate a relative position trajectory from the movement characteristic data. The portable terminal 200 may estimate the relative position trajectory from movement characteristic data by using a pre-trained relative position estimation model.

The portable terminal 200 may estimate a relative position at which the portable terminal 200 is expected to be positioned at each of points in time at which movement characteristic data is acquired. A set of estimated relative positions may constitute the relative position trajectory. For example, the pre-trained relative position estimation model may estimate the relative displacement of the carrier from acceleration data included in the movement characteristic data acquired at each point in time, and may estimate the relative position at the corresponding point in time by using the relative displacement and the position estimated at the previous point in time. Here, the relative position and the relative position trajectory indicate a virtual position and a virtual trajectory, respectively because they do not use absolute criteria. That is, unlike models used in general dead-reckoning techniques, the relative position estimation model does not use the absolute criteria (e.g., landmarks, true position values of initial positions, and the like) to estimate the relative position. Accordingly, it is important to note that the relative position estimated by the relative position estimation model represents a relative position based on virtually set criteria, not the absolute criteria.

In an embodiment, the portable terminal 200 may estimate a plurality of relative position trajectories from the movement characteristic data included in each of the training datasets. In this case, the portable terminal 200 may estimate relative position trajectories as many as the number of training datasets acquired.

According to an embodiment, the relative position estimation model may be pre-trained to be optimized for the characteristics of the sensor that acquires the movement characteristic data. For example, when the movement characteristic data is acquired from an inertial measurement unit (IMU) sensor, the relative position estimation model may be optimized for data acquired from the IMU sensor by performing training so as to estimate the relative position trajectory from data acquired by using the IMU sensor during a training process. In this way, the relative position estimation model may derive the relative position estimation performance that is trained and optimized by using pieces of data acquired by the same sensor as the sensor that acquires the movement characteristic data from the portable terminal 200 and/or the user terminal 300.

For example, the relative position estimation model may obtain the movement characteristic data while a user moves outdoors with a terminal equipped with the same sensor as the sensor provided to the user terminal 300, may obtain a true position value for performing training from a GPS sensor, or the like, and may train a method of estimating a relative position from the movement characteristic data. It is important to note that the true position value mentioned here is used in a process of training the relative position estimation model.

The relative position estimation model may include a neural network for training. The neural network may include various types of neural networks such as ResNet, RNN, TCN, and CNN, and may not be limited to the aforementioned model.

According to an embodiment, the relative position estimation model may go through a process of preprocessing the movement characteristic data. The movement characteristic data may be obtained from the portable terminal 200. Because the absolute direction of the portable terminal 200 is incapable of being estimated, the movement characteristic data may be preprocessed by arbitrarily setting a reference direction. In this case, the relative position estimation model estimates the direction of the portable terminal 200 based on an arbitrary direction, and thus when the movement of the portable terminal 200 is accumulated, an error in a process of estimating a direction and a distance may be accumulated, thereby making the relative position trajectory inaccurate. Accordingly, according to an embodiment, the data collection SDK may determine the accumulated error, and may filter or correct the data when the accumulated error exceeds a specific level.

According to an embodiment, the data collection SDK may include a pre-trained relative position estimation model. The portable terminal 200 may estimate a relative position trajectory from the movement characteristic data by using the data collection SDK.

In operation S150, the management server 100 may receive the signal strength data and the relative position trajectory from the portable terminal 200.

In an embodiment, the management server 100 may receive a plurality of training datasets for the signal strength data and the relative position trajectory. Each training dataset of each of the pieces of training data includes the signal strength data and the relative position trajectory acquired during each movement path of the portable terminal 200.

Furthermore, the management server 100 may further receive a map for a target space from the client server 400.

In operation S160, the management server 100 may train a position-tracking model. The position-tracking model may be trained to estimate an absolute position from the relative position trajectory and the signal strength data. Because the signal strength data does not include data regarding a position, the position-tracking model may be trained to estimate the absolute position by using the relative positions included in the relative position trajectory.

The position-tracking model may include a neural network for training, and the neural network may include various types of neural networks such as ResNet, RNN, TCN, and CNN, and may not be limited to the above-mentioned model.

The positioning service providing system 10 disclosed in the specification may use a relative position estimated from the movement characteristic data, which is acquired while a carrier moves, instead of collecting a true position value in a process of collecting the signal strength data, thereby reducing the costs and time required to construct a database and ensuring the accuracy and reliability of positioning.

According to an embodiment, the management server 100 may include an autoencoder that converts the signal strength data into a data format suitable for training. The autoencoder may receive the signal strength data, may convert the input data into a data format suitable for training, and may output the converted data so as to be input to the position-tracking model.

According to an embodiment, the management server 100 may fuse the relative position trajectory and the signal strength data. In other words, because the signal strength data does not include data regarding position information, the management server 100 may utilize relative positions included in the relative position trajectory as the position information of the signal strength data. For example, the fusing of the relative position trajectory and the signal strength data may mean combining signal strength data and the relative position estimated from the movement characteristic data, which are acquired at the same time, and expressing the combined result as single data. For example, when the signal strength vector acquired at time ‘t’ is Rt and the relative position on the relative position trajectory calculated at time ‘t’ is (xt, yt), the management server 100 may fuse the signal strength vector and the relative position and may express the fused result as a three-dimensional vector of (xt, yt, rt). Even when the relative position trajectory and the signal strength data are fused, the signal strength data does not include data regarding the position information, and thus the shape of a path represented by the relative position trajectory is not changed.

In an embodiment, the management server 100 may receive the pieces of training data and may fuse the relative position trajectory and the signal strength data corresponding to each of the pieces of training data. The position-tracking model may receive data obtained by fusing the signal strength data and the relative position trajectory and may output an absolute position.

According to an embodiment, the position-tracking model may train a method of estimating the absolute position through a process of performing the conversion of each relative position trajectory such that points having the same signal strength data have the same absolute position with respect to a plurality of relative position trajectories with which the signal strength data is fused.

The signal strength data is a set of pieces of signal strength data received from AP within the target space, and thus when a point at which the signal strength data is received is changed, the direction and/or magnitude of at least one strength data among pieces of data constituting the signal strength data is changed. Accordingly, the management server 100 may determine that the point having the same signal strength data on the same relative position trajectory and/or different relative position trajectories is acquired at a point having the same absolute position.

For example, when r1 and r2 in data (x1, y1, r1) included in the fused first relative position trajectory and data (x2, y2, r2) included in the fused second relative position trajectory are the same vectors, the position-tracking model may determine that (x1, y1) and (x2, y2), which are relative positions, have the same absolute positions, may convert the first relative position trajectory and the second relative position trajectory by converting both data (x1, y1, r1) and data (x2, y2, r2) into data (x3, y3, r1). Here, (x3, y3) may be an absolute position estimation value estimated by the training result up to the previous training process of the position-tracking model.

According to an embodiment, the position-tracking model may be trained to estimate the absolute position in further consideration of geometrical characteristics of the target space. The geometrical characteristics of the target space may include the placement of a physical structure (e.g., a wall) in the target space, the shape of a passageway, and the like. For example, the geometric characteristics of the target space may include characteristics of an area where a person is capable of walking within the target space, and an area (e.g., an area blocked by walls) where a person is incapable of walking within the target space. For example, the geometric characteristics of the target space may be determined based on a map of the target space received from the client server 400.

The position-tracking model further takes into account the geometric characteristics of the target space in a process of converting the relative position trajectory such that all or part of a trajectory, in which each relative position trajectory is converted, does not overlap a position that is not present, thereby enabling accurate training. In this way, the positioning service providing system 10 may provide a positioning service optimized for the target space by performing training in further consideration of the geometric characteristics of the target space.

According to an embodiment, the management server 100 may map the absolute position onto a map for the target space. In an embodiment, the mapping of the absolute position onto the target space may be trained by the position-tracking model. For another example, it is also possible that the absolute position estimated from the position-tracking model trained by the processor of the management server 100, not the position-tracking model, is mapped onto the map.

In operation S170, the user terminal 300 may receive the position-tracking SDK from the management server 200. The user terminal 300 may store and execute the position-tracking SDK. The position-tracking SDK may include a trained position-tracking model, and may further include a pre-trained relative position estimation model and/or an autoencoder.

In operation S180, the user terminal 300 may acquire the movement characteristic data and the signal strength data. When a user moves within the target space while carrying the user terminal 300, the user terminal 300 may obtain the movement characteristic data and the signal strength data during the user's movement. In this case, the movement characteristic data and the signal strength data may be acquired periodically depending on each sensing cycle.

In operation S190, the user terminal 300 may estimate the absolute position from the signal strength data and a relative position estimated based on the movement characteristic data. In more detail, the position-tracking SDK may calculate the absolute position from the relative position and the signal strength data.

In operation S200, the user terminal 300 may determine whether the user is moving. The processor of the user terminal 300 may determine the user's state as a moving state or a stopped state. In more detail, the position-tracking SDK may determine whether the user is moving. For example, the position-tracking SDK may determine whether the user is moving, based on an average value or a variance value of the user's absolute position.

For example, when the average of changes in absolute positions is less than a threshold value, the position-tracking SDK may determine that the user is in a stopped state. For another example, when the variance value of absolute positions is greater than or equal to the threshold value, the position-tracking SDK may determine that the user is in a moving state.

According to an embodiment, the user terminal 300 may determine whether to transmit the absolute position to the management server 200, based on whether the user is moving.

In an embodiment, when the user is determined to be in a stopped state, the user terminal 300 may not transmit the absolute position to the management server. In this case, the management server may maintain the user's position as a position received from the previous point in time. On the other hand, when the user is determined to be in a moving state, the user terminal 300 may be configured to transmit the absolute position to the management server.

In this way, the user terminal 300 and the management server 200 may reduce unnecessary communication and increase security and accuracy.

In operation S210, the management server 100 may receive the absolute position from the user terminal 300.

In operation S220, the management server 100 may provide user control. For example, the management server 100 may simultaneously track real-time positions of a plurality of users by implementing the absolute position received from the user terminal 300 by using an real-time location system (RTLS), may analyze an absolute position history of a specific user, may express the analyzed result as a heat map, and may provide various pieces of information, such as expressing the user's position history by time zone. In an embodiment, the user terminal 300 may implement a control platform for providing the control of users and may provide the control platform to the client.

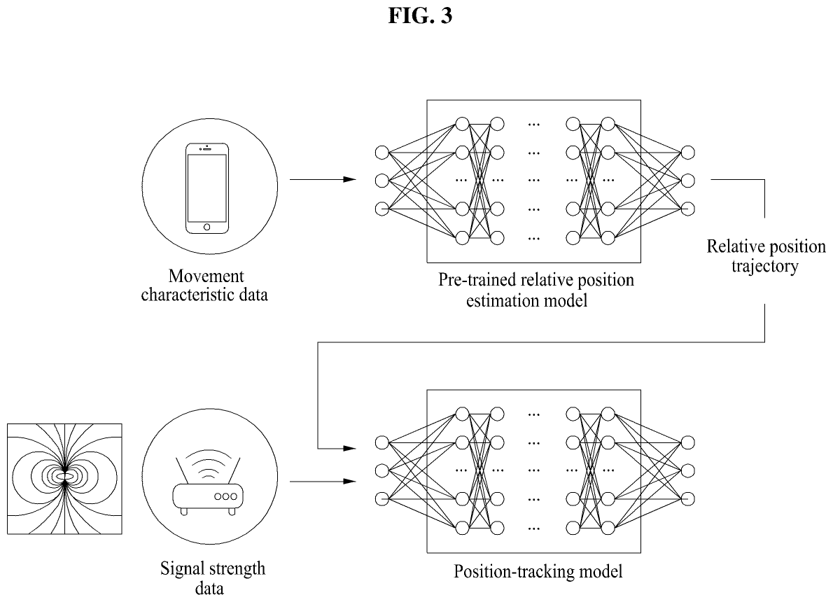

FIG. 3 is a diagram showing a process of estimating an absolute position from movement characteristic data and signal strength data, according to an embodiment disclosed in the specification.

Referring to FIG. 3, the positioning service providing system 10 may estimate a relative position trajectory by using a pre-trained relative position estimation model from movement characteristic data, may fuse the estimated relative position trajectory and signal strength data, may input the fused result to a position-tracking model, and may train a process in which the position-tracking model estimates an absolute position. According to an embodiment, the signal strength data may include at least one of Wi-F-RSSI data and magnetic field data.

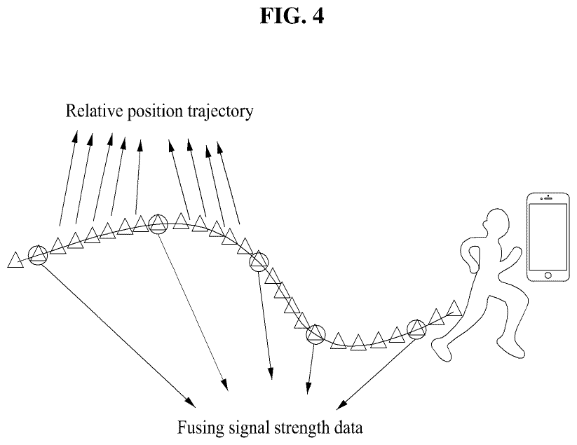

FIG. 4 is a diagram showing an example of fusion of a relative position trajectory and signal strength data, according to an embodiment disclosed in the specification.

Referring to FIG. 4, the management server 100 may fuse a relative position trajectory and the signal strength data. A set of points expressed as triangles in FIG. 4 represents the relative position trajectory, and points represented by overlapping triangles and circles represent fusing signal strength vectors, which are acquired at the same time, with the relative position trajectory.

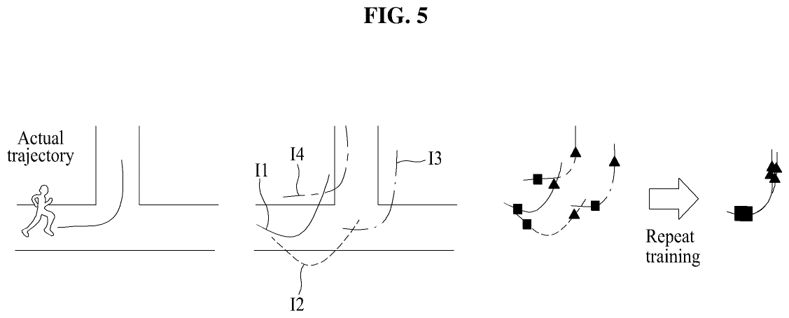

FIG. 5 is a diagram showing an example of a process of converting a plurality of relative position trajectories, according to an embodiment disclosed in the specification.

Referring to FIG. 5, relative position trajectories obtained from a predetermined relative position estimation model do not use absolute criteria (e.g., a landmark or an initial true position value), and thus different relative position trajectories may be estimated even when a user moves along the same trajectory. That is, even when a user or a carrier actually and repeatedly moves along the same trajectory, a relative position trajectory estimated from the relative position estimation model may be estimated differently such as a solid line trajectory I1, a dotted line trajectory I2, a dash-single dotted line trajectory I3, or a dash-double dotted line trajectory I4 in FIG. 5. In this case, the position-tracking model may convert each of a plurality of relative position trajectories such that points having the same signal strength data have the same position in a plurality of relative position trajectories. In the right drawing of FIG. 5, points having the same shape (triangle or square) may move to points having the same signal strength data. A position-tracking model may be trained by repeatedly converting each relative position trajectory such that points having the same shape have the same position in each relative position trajectory.

The position-tracking model may estimate the absolute position by training a process of converting a plurality of relative position trajectories in this way. It is obvious that the training process is applied to not only a case of repeatedly moving on the same trajectory, but also a case of moving on different trajectories. The position-tracking model may estimate the absolute position from the relative position of movement characteristic data without absolute criteria, by training a process of converting the relative position trajectory.

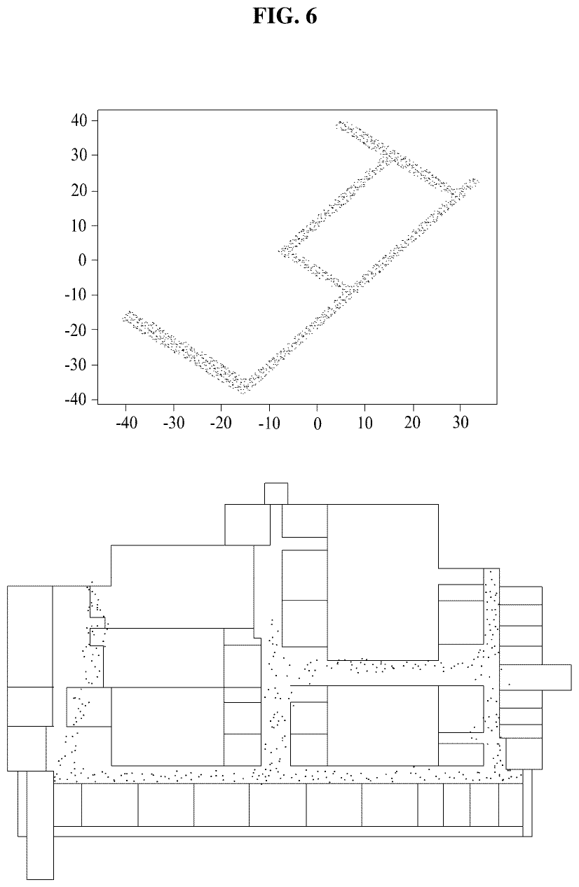

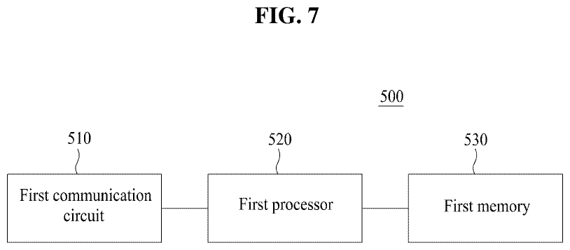

FIG. 6 is a diagram showing an example of mapping an absolute position onto a map, according to an embodiment disclosed in the specification.

Referring to FIG. 6, the management server 100 may receive a map for a target space from the client server 400 and may express the absolute position by mapping the absolute position onto the map. For example, when the absolute position is estimated as in the upper end of FIG. 6, the absolute position may be converted to correspond to the size and direction of the actual map and may be mapped onto the map.

According to an embodiment, the management server 100 may further consider the geometric characteristics of the target space. For example, the management server 100 may map the absolute position in further consideration of the structure of a passage, through which a person is capable of walking, within the target space during a process of mapping the absolute position onto the map.

FIG. 7 is a block diagram showing a configuration of a management server, according to an embodiment disclosed in the specification.

Referring to FIG. 7, a management server 500 (e.g., the management server 100 of FIG. 1) according to an embodiment may include a first communication circuit 510, a first processor 520, and a first memory 530.

The first communication circuit 510 may establish a wired or wireless communication connection between the management server 500 and an external electronic device (e.g., a user terminal, a portable terminal, or the like) and may support communication execution through the established communication connection. According to an embodiment, the first communication circuit 510 may include a wireless communication circuit (e.g., a cellular communication circuit, a short-range wireless communication circuit, or a global navigation satellite system (GNSS) communication circuit) or a wired communication module (e.g., a local area network (LAN) communication circuit or a power line communication circuit) and may communicate with the external electronic device by using a corresponding communication circuit among them through the short-range communication network such as a Bluetooth, a WiFi direct, or an infrared data association (IrDA)) or the long-distance communication network such as a cellular network, an Internet, or a computer network. The above-mentioned various first communication circuits 510 may be implemented into one chip or may be respectively implemented into separate chips. In an embodiment, the first communication circuit 510 of the management server 500 may communicate with the portable terminal 200 and the user terminal 300 of FIG. 1.

The first processor 520 may control overall operations of the management server 500. In various embodiments, the first processor 520 may include a single processor core or may include a plurality of processor cores. For example, the first processor 520 may include a multi-core such as a dual-core, a quad-core, a hexa-core, or the like. According to embodiments, the first processor 520 may further include a cache memory positioned inside or outside the first processor 520. According to embodiments, the first processor 520 may be configured with one or more processors. For example, the first processor 520 may include at least one of an application processor, a communication processor, or a graphical processing unit (GPU).

All or part of the first processor 520 may be electrically or operatively coupled with or connected to another component (e.g., the first communication circuit 510 or the first memory 530) within the management server 500. The processor 520 may receive a command from other components, may interpret the received command, and may perform calculations or process data depending on the interpreted command. The first processor 520 may interpret and process messages, data, instructions, or signals received from the first communication circuit 510 and the first memory 530. The first processor 520 may generate new messages, data, instructions, or signals based on the received messages, data, instructions, or signals. The first processor 520 may provide the processed or generated messages, data, instructions, or signals to the first communication circuit 510 or the first memory 530.

The processor 520 may process data or signals, which is generated by a program and occurs in a program. For example, the first processor 520 may request instructions, data, or signals from the first memory 530 to execute or control a program. The first processor 520 may write (or store) or update instructions, data, or signals to the first memory 530 to execute or control the program. In an embodiment, the first processor 520 may train a position-tracking model stored in the first memory 530.

The first memory 530 may store instructions for controlling a server, control command codes, control data, or user data. For example, the first memory 530 may include at least one of an application program, an operating system (OS), middleware, or a device driver. The first memory 530 may include one or more of a volatile memory or a non-volatile memory. The volatile memory may include a dynamic random access memory (DRAM), a static RAM (SRAM), a synchronous DRAM (SDRAM), a phase-change RAM (PRAM), a magnetic RAM (MRAM), a resistive RAM (RRAM), a ferroelectric RAM (FeRAM), and the like. The non-volatile memory may include a read only memory (ROM), a programmable ROM (PROM), an electrically programmable ROM (EPROM), an electrically erasable programmable ROM (EEPROM), a flash memory, and the like. The first memory 530 may further include nonvolatile media (medium) such as a hard disk drive (HDD), a solid state disk (SSD), an embedded multimedia card (eMMC), and universal flash storage (UFS). In an embodiment, the first memory 530 may store a pre-trained relative position estimation model and/or a pre-trained position-tracking model.

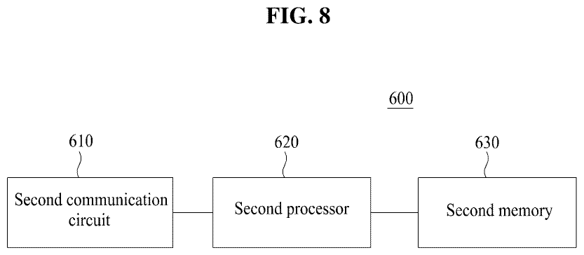

FIG. 8 is a block diagram showing a configuration of a user terminal, according to an embodiment disclosed in the specification.

Referring to FIG. 8, a user terminal 600 (e.g., the user terminal 300 of FIG. 1) according to an embodiment may include a second communication circuit 610, a second processor 620, and a second memory 630.

The second communication circuit 610 may establish a wired or wireless communication connection between the user terminal 600 and an external electronic device (e.g., a management server) and may support communication execution through the established communication connection. According to an embodiment, the second communication circuit 610 may have a configuration substantially the same as the first communication circuit 510 of FIG. 7. In an embodiment, the second communication circuit 610 of the user terminal 600 may communicate with the management server 100.

The second processor 620 may control overall operations of the user terminal 600. In an embodiment, the second processor 620 may be substantially the same as the first processor 520 of FIG. 7.

The second memory 630 may store instructions for controlling a server, control command codes, control data, or user data. In an embodiment, the second memory 630 may be substantially the same as the first memory 630 of FIG. 7.

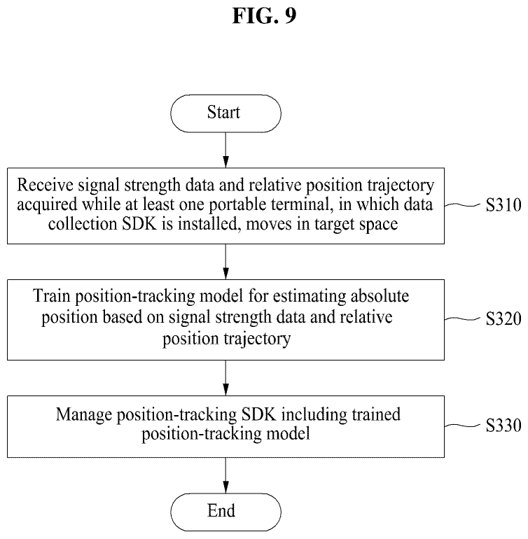

FIG. 9 is a flowchart for describing an operating method of a management server, according to an embodiment disclosed in the specification.

Referring to FIG. 9, an operating method of a management server may include operation S310 of receiving signal strength data and a relative position trajectory acquired while at least one portable terminal, in which a data collection SDK is installed, moves in a target space, operation S320 of training a position-tracking model for estimating an absolute position based on the signal strength data and the relative position trajectory, and operation S330 of managing a position-tracking SDK including the trained position-tracking model.

In operation S310, the management server 100 may receive the signal strength data and the relative position trajectory from the portable terminal 200. The signal strength data and the relative position trajectory may be data acquired as the portable terminal 200, in which the data collection SDK is installed, moves within the target space. The relative position trajectory may be estimated based on movement characteristic data acquired while the portable terminal 200 moves within the target space. The data collection SDK may store data acquired from the portable terminal 200 or may deliver the data to the management server 100.

According to an embodiment, the management server 100 may receive a plurality of training datasets for the signal strength data and the relative position trajectory from the portable terminal.

In operation S320, the management server 100 may train the position-tracking model for estimating the absolute position based on the signal strength data and the relative position trajectory. The position-tracking model may train a method of estimating the absolute position by converting the relative position trajectory by fusing the signal strength data with the relative position trajectory.

According to an embodiment, the position-tracking model may estimate the absolute position by training a process of converting each of a plurality of relative position trajectories such that points with the same signal strength data have the same absolute position.

In operation S330, the management server 100 may manage the position-tracking SDK including the trained position-tracking model. For example, the management server 100 may enable positioning of users by distributing the position-tracking SDK to the client's users. For another example, the management server 100 may continuously update and manage the position-tracking model and the position-tracking SDK including the same depending on changes in the target space, changes in sensors of a terminal (e.g., a portable terminal) where the data collection SDK is installed, or the like.

In the above, even though all components constituting an embodiment disclosed in the specification are described as being combined to one or operating in combination, embodiments disclosed in the specification are not necessarily limited to the embodiment. That is, within the scope of embodiments disclosed in the specification, all components may be selectively combined and may perform a function(s).

In addition, the terms such as “comprise”, “include”, and “have” described above mean that the corresponding component may be included, unless there is a particularly contrary statement, and should be interpreted as further including another component, not excluding another component. Unless otherwise defined herein, all the terms used herein, which include technical or scientific terms, may have the same meaning that is generally understood by a person skilled in the art to which embodiments disclosed in the specification pertain. Terms commonly used, such as those defined in the dictionary, should be interpreted as having a meaning that is consistent with the meaning in the context of the related art and will not be interpreted as having an idealized or overly formal meaning unless expressly defined in in the specification.

Hereinabove, the above description is merely illustrative of the technical idea disclosed in the specification, and various modifications and variations may be made by one skilled in the art, to which the embodiments disclosed in the specification belong, without departing from the essential characteristic of the embodiments disclosed in the specification. Therefore, embodiments disclosed in the specification are intended not to limit but to explain the technical idea of embodiments disclosed in the specification, and the scope of the technical idea disclosed in the specification is not limited by this embodiment. The scope of protection disclosed in the specification should be construed by the attached claims, and all equivalents thereof should be construed as being included within the scope of the specification.

INDUSTRIAL APPLICABILITY

1. A management server comprising:
a communication circuit;
a memory; and
a processor operatively connected to the communication circuit and the memory,
wherein the processor is configured to:
receive signal strength data and a relative position trajectory estimated based on movement characteristic data acquired while at least one portable terminal, in which a data collection SDK is installed, moves in a target space;
train a position-tracking model for estimating an absolute position based on the signal strength data and the relative position trajectory; and
manage a position-tracking SDK including the trained position-tracking model.

2. The management server of claim 1, wherein the processor is configured to:
receive a plurality of training datasets for the signal strength data and the relative position trajectory; and
fuse a relative position trajectory and signal strength data corresponding to each of the training datasets, and
wherein the position-tracking model is trained to estimate the absolute position by converting each of relative position trajectories fused such that points with the same signal strength data have the same absolute position.

3. The management server of claim 2, wherein the position-tracking model is trained to estimate the absolute position in further consideration of geometric characteristics of the target space.

4. The management server of claim 1, wherein the processor is configured to:
receive a map of the target space from a client server and map the estimated absolute position onto the map.

5. The management server of claim 1, wherein the signal strength data includes at least one of Wi-Fi Received Signal Strength Indicator (RSSI) data and magnetic field data.

6. The management server of claim 1, wherein the movement characteristic data includes at least one of inertial sensor data and gyro sensor data.

7. The management server of claim 1, wherein the data collection SDK is configured to filter noise data of the signal strength data and the movement characteristic data that are acquired.

8. The management server of claim 1, wherein the data collection SDK is configured to estimate the relative position trajectory from the movement characteristic data by using a pre-trained relative position

9. An operating method of a management server, the method comprising:
receiving signal strength data and a relative position trajectory estimated based on movement characteristic data acquired while at least one portable terminal, in which a data collection SDK is installed, moves in a target space;
training a position-tracking model for estimating an absolute position based on the signal strength data and the relative position trajectory; and
managing a position-tracking SDK including the trained position-tracking model.

10. The method of claim 9, wherein the receiving of the signal strength data and the relative position trajectory dynamically acquired from the portable terminal, in which the data collection SDK is installed, in a position-tracking target space includes:
receiving a plurality of training datasets for the signal strength data and the relative position trajectory,
wherein the estimating of the relative position trajectory from the movement characteristic data by using the pre-trained relative position estimation model includes:
fusing a relative position trajectory and signal strength data corresponding to each of the training datasets, and
wherein the training of the position-tracking model for estimating the absolute position based on the signal strength data and the relative position trajectory includes:
being trained to estimate the absolute position by converting each of a plurality of relative position trajectories fused such that points with the same signal strength data have the same absolute position.

11. A user terminal comprising:
a communication circuit;
a memory; and
a processor operatively connected to the communication circuit and the memory,
wherein the processor is configured to:
receive a position-tracking SDK from a management server, install the position-tracking SDK in the memory, and acquire movement characteristic data and signal strength data as a user moves within a target space; and
estimate an absolute position of the user from the signal strength data and a relative position estimated based on the movement characteristic data by using the position-tracking SDK.

12. The user terminal of claim 11, wherein the processor is configured to:
determine whether the user is moving, based on the absolute position; and
determine whether to deliver the absolute position to the management server, based on whether the movement occurs.

13. The user terminal of claim 12, wherein the processor is configured to:
not deliver the absolute position to the management server when the user is determined to be in a stopped state; and
deliver the absolute position to the management server when the user is determined to be in a moving state.
